(19) United States
(12) Patent Application Publication
(10) Pub. No.: US 2008/0106666 A1
(43) Pub. Date: May 8, 2008

(54) LIQUID CRYSTAL DISPLAY

(76) Inventors: Yo-han Lee, Asan-si (KR); Young-gil Kim, Suwon-si (KR); Seoung-bum Pyoun, Osan-si (KR); Sung-hee Lee, Yongin-si (KR); Sang-iun Lee, Jeollanam-do (KR)

Correspondence Address: F. CHAU & ASSOCIATES, LLC, 130 WOODBURY ROAD, WOODBURY, NY, 11797, US

(21) Appl. No.: 11/877,888

(22) Filed: Oct. 24, 2007

(30) Foreign Application Priority Data
Nov. 2, 2006 (KR) 10-2006-0107911

(51) Int. Cl. G02F 1/136

(52) U.S. Cl. 349/48

(57) ABSTRACT

A liquid crystal display capable of preventing a residual image phenomenon from occurring after power is cut off. The liquid crystal display includes: a voltage generating unit outputting a gate-on voltage to a first output node, outputting a gate-off voltage to a second output node, and pulling up the voltage level of the second output node to a level of a positive discharge voltage after a power supply voltage is cut off; a gate driving unit sequentially supplying the gate-on voltage and the gate-off voltage; a data driving unit supplying an image data voltage; and a liquid crystal panel including a plurality of pixels that are turned on or off according to the gate-on voltage or the gate-off voltage, so as to display an image corresponding to the image data voltage.

### CROSS REFERENCE TO RELATED APPLICATION

This application claims priority from Korean Patent Application No. 10-2006-0107911 filed on Nov. 2, 2006 in the Korean Intellectual Property Office, the disclosure of which is incorporated herein by reference in its entirety.

### BACKGROUND OF THE INVENTION

1. Technical Field

The present disclosure relates to a liquid crystal display.

2. Discussion of Related Art

Liquid crystal displays include a liquid crystal panel having a plurality of gate lines and a plurality of data lines, a gate driving unit sequentially supplying gate-on and gate-off voltages to the plurality of gate lines, and a data driving unit supplying an image data voltage to the plurality of data lines. The liquid crystal panel includes a plurality of switching elements that are turned on/off by a gate-on/off signal and a plurality of pixel electrodes to which the image data voltage is charged.

For each frame, the gate-on voltage is applied to each gate line once and the gate-off voltage is applied to each gate line for the remaining period. More specifically, at one time point, only the switching elements connected to one gate line are in a turned-on state and the other switching elements connected to the other gate lines are in a turned-off state.

By interrupting a power voltage supplied to the liquid crystal display, if the gate-off voltage does not change to a ground voltage within a short period of time, most of the switching elements will be maintained in the turned-off state, as a result the image data voltage charged in the pixel electrodes will not discharge. For this reason, even after interrupting the power supply, a residual image phenomenon is observed.

### SUMMARY OF THE INVENTION

Exemplary embodiments of the present invention provide a liquid crystal display capable of preventing a residual image phenomenon after interrupting a power voltage.

According to an exemplary embodiment of the present invention, there is provided a liquid crystal display including: a voltage generating unit outputting a gate-on voltage to a first output node, outputting a gate-off voltage to a second output node, and pulling the voltage level of the second output node up to a level of a positive discharge voltage after a power supply voltage is cut off; a gate driving unit sequentially supplying the gate-on voltage and the gate-off voltage; a data driving unit supplying an image data voltage; and a liquid crystal panel comprising a plurality of pixels that are turned on or off according to the gate-on voltage or the gate-off voltage so as to display an image corresponding to the image data voltage.

According to an exemplary embodiment of the present invention, there is provided a liquid crystal display including: a voltage generating unit comprising a gate-on voltage generating unit outputting a gate-on voltage to a first output node, a gate-off voltage generating unit outputting a gate-off voltage to a second output node, a pull-up unit pulling the voltage level of the second output node up to the level of the gate-on voltage when a power supply voltage is cut off, and a first cut-off unit electrically disconnecting the second output node and the gate-off voltage generating unit when the power supply voltage is cut off, a gate driving unit sequentially supplying the gate-on voltage and the gate-off voltage; a data driving unit supplying an image data voltage; and a liquid crystal panel comprising a plurality of pixels that are turned on or off according to the gate-on voltage or the gate-off voltage so as to display an image corresponding to the image data voltage, each pixel being supplied with the gate-on voltage so as to discharge the image data voltage when the power supply voltage is cut off.

### BRIEF DESCRIPTION OF THE DRAWINGS

Exemplary embodiments of the present invention will be understood in more detail from the following descriptions taken in conjunction with the attached drawings in which:

FIG. 1 is a block diagram illustrating a liquid crystal display according to an exemplary embodiment of the present invention;

FIG. 2 is a diagram illustrating an equivalent circuit of one pixel of the liquid crystal display according to an exemplary embodiment of the present invention;

FIG. 3 is a diagram illustrating a signal for explaining a voltage generating unit shown in FIG. 1;

FIG. 4 is a block diagram illustrating a voltage generating unit according to an exemplary embodiment of the present invention;

FIG. 5 is a circuit diagram illustrating an exemplary embodiment of an internal circuit of a driving voltage generating unit shown in FIG. 4;

FIG. 6 is a circuit diagram illustrating an exemplary embodiment of an internal circuit of a gate-on voltage generating unit shown in FIG. 4;

FIG. 7 is a circuit diagram illustrating an exemplary embodiment of an internal circuit of a gate-off voltage generating unit shown in FIG. 4;

FIG. 8 is a circuit diagram illustrating a pull-up unit and a first interrupting unit of a liquid crystal display according to an exemplary embodiment of the present invention;

FIG. 9 is a circuit diagram illustrating a pull-up unit and a first interrupting unit of a liquid crystal display according to an exemplary embodiment of the present invention; and

FIGS. 10A and 10B are circuit diagrams illustrating a voltage generating unit of a liquid crystal display according to an exemplary embodiment of the present invention.

### DESCRIPTION OF EXEMPLARY EMBODIMENTS

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present invention will now be described more fully with reference to the accompanying drawings, in which exemplary embodiments of the invention are shown.

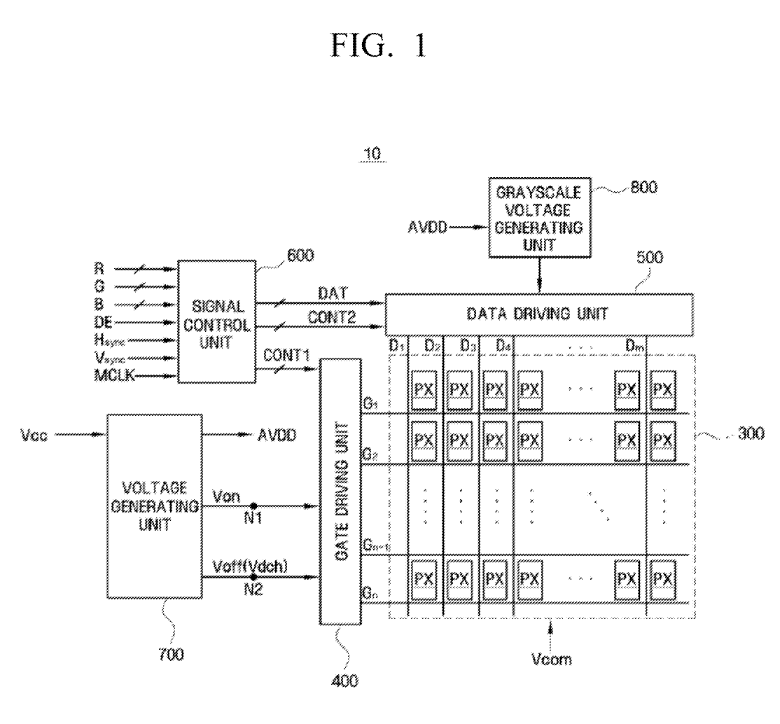

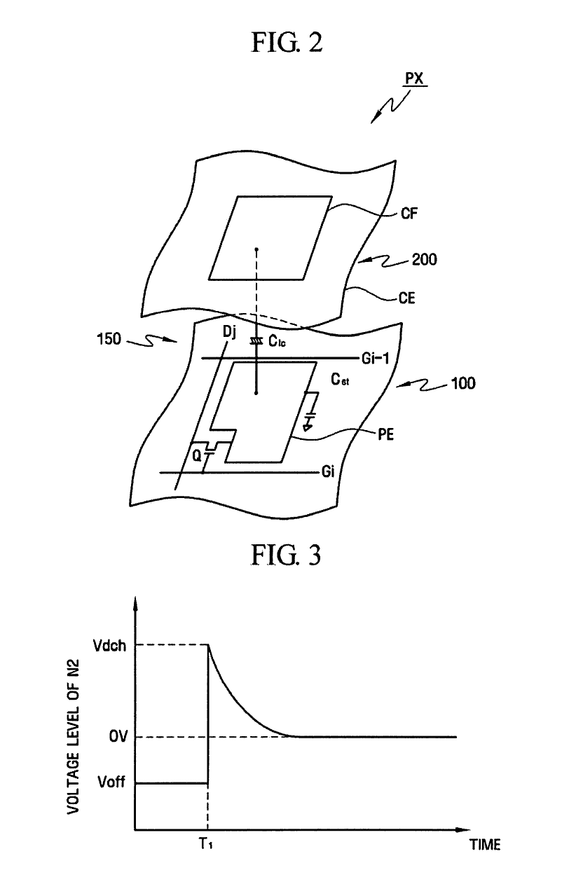

FIG. 1 is a block diagram illustrating a liquid crystal display 10 according to an exemplary embodiment of the invention, FIG. 2 is a diagram illustrating an equivalent circuit of one pixel of the liquid crystal display according to an exemplary embodiment of the present invention, and FIG. 3 is a diagram illustrating a signal for explaining a voltage generating unit shown in FIG. 1.

Referring to FIG. 1, a liquid crystal display 10 includes a liquid crystal panel 300, a gate driving unit 500, a data driving unit 600, a voltage generating unit 700, and a grayscale voltage generating unit 800.

The liquid crystal panel 300 includes a plurality of gate lines G₁ to Gₙ, a plurality of data lines D₁ to Dₙ, and a plurality of pixels PX formed at the intersections of the plurality of gate lines G₁ to Gₙ and the plurality of data lines D₁ to Dₙ.

The gate lines G₁ to Gₙ substantially extend in a row direction so as to be parallel to one another, and the data lines D₁ to Dₘ substantially extend in a column direction so as to be parallel to one another.

Referring to FIG. 2, color filters CF can be formed in a portion of a region of a common electrode CE of a second substrate 200 so as to face pixel electrodes of a first substrate 100. For example, a pixel PX connected to an i-th (i=1, 2, . . . , n) gate line Gᵢ and a j-th(j=1, 2, . . . , m) data line Dⱼ includes a switching element Q, and a liquid crystal capacitor Clc and a storage capacitor Cst connected to the switching element Q. The storage capacitor Cst may be omitted, if necessary. The switching element Q may be a thin film transistor (TFT) formed of amorphous silicon (referred to as a-Si).

When a gate-on voltage Von is applied to the gate line Gᵢ, the switch Q is turned on. Then, an image data voltage applied to the data line Dⱼ is applied to the corresponding pixel electrode PE through the switching element Q that is turned on.

The liquid crystal is changed in orientation according to the difference between the image data voltage applied to the pixel electrode PE and a common voltage Vcom applied to the common electrode CE so as to display an image.

When a gate-off voltage Voff is applied to the gate line Gᵢ, the switching element Q is turned off. Then, the image data voltage applied to the pixel electrode PE is maintained.

The gate driving unit 400 is supplied with a gate control signal CONT1 from the signal control unit 600 and sequentially supplies the gate-on voltage Von or the gate-off voltage Voff to the plurality of gate lines G₁ to Gₙ. The gate-on voltage Von is supplied from the voltage generating unit 700 through a first output node N1, and the gate-off voltage Voff is supplied from the voltage generating unit 700 through a second output node N2.

In this exemplary embodiment, the gate control signal CONT1 is used to control the operation of the data driving unit 400 and any of the following signals may be used as the gate control signal CONT1: a vertical start signal for starting the operation of the gate driving unit 400, a gate clock signal for determining the timing to output the gate-on voltage Von, an output enable signal for determining the pulse width of the gate-on voltage Von, and the like.

The data driving unit 500 is supplied with a data control signal CONT2, selects an image data voltage from a plurality of grayscale voltages supplied from the grayscale voltage generating unit 800, and applies the selected image data voltage to the data lines D₁ to Dₘ. In this exemplary embodiment, the data control signal CONT2 controls the operation of the data driving unit 500 and any of the following signals may be used as the data control signal CONT2: a horizontal start signal for starting the operation of the data driving unit 500, a load signal for instructing to output two data voltages, and the like.

The voltage generating unit 700 is supplied with a power supply voltage Vcc from the outside and generates and outputs the gate-on voltage Von and the gate-off voltage Voff. That is, the voltage generating unit 700 is supplied with the power supply voltage Vcc and generates a plurality of voltages needed for the operation of the liquid crystal display 10.

In this exemplary embodiment, a driving voltage AVDD is used to generate a plurality of grayscale voltages and is applied to the grayscale voltage generating unit 800. When the driving voltage AVDD is applied, the grayscale voltage generating unit 800 divides the voltage using a resistor string to generate a plurality of grayscale voltages.

The gate-on voltage Von is applied to the gate driving unit 400 through the first output node N1, and the gate-off voltage Voff is applied to the gate driving unit 400 through the second output node N2. In this exemplary embodiment, the gate-on voltage Von may be, for example, a positive voltage of 21V and the gate-off voltage Voff may be, for example, a negative voltage of −7V.

When the power supply voltage Vcc of the liquid crystal panel 10 is cut off, that is, when the liquid crystal display 10 is turned off, the voltage generating unit 700 pulls the voltage level of the second output node N2 up to the level of a positive discharge voltage Vdch. That is, after the power supply voltage Vcc is cut off, the gate driving unit 400 is supplied with the discharge voltage Vdch through the second output node N2 and supplies the discharge voltage Vdch to the plurality of gate lines G₁ to Gₙ.

Referring to FIGS. 2 and 3, the operation and function of the voltage generating unit 700 will be described in more detail.

FIG. 3 shows the voltage level of the second output node N2 as a function of time.

First, before a time T₁, the voltage level of tie second output node N2 is maintained at the gate-off voltage Voff of, for example, −7V.

At the time T₁, when the power supply voltage Vcc is cut off, the voltage level of the second output node N2 is pulled up to the discharge voltage Vdch and then gradually decreased.

That is, the voltage generating unit 700 pulls the voltage level of the second output node N2 up to the positive discharge voltage Vdch at the time T₁. Therefore, after the time T₁, the gate driving unit 400 supplies the discharge voltage Vdch output from the second output node N2 to the plurality of gate lines G₁ to Gₙ, instead of the gate-off voltage Voff.

The discharge voltage is supplied to, for example, the i-th gate line Gᵢ, and thus the corresponding switching element Q is turned on. At this time, since the power supply voltage Vcc has been cut off, the image data voltage may not be applied to the j-th data line Dⱼ. Therefore, tile image data voltage having been charged in the pixel electrode PE is discharged through the switching element Q that has been turned on.

That is, after the power supply voltage Vcc is cut off, since the positive discharge voltage Vdch is supplied to the switching element Q of each pixel PE, the image data voltage having been charged in each of the plurality of pixel electrodes PE is discharged through the switching element Q having been turned on within a short time. Therefore, it is possible to prevent a residual image phenomenon after the power supply voltage Vcc is cut off.

Meanwhile, the gate driving unit 400 or the data driving unit 500 may be directly mounted on the liquid crystal panel 300 in the form of a plurality of IC chips or may be mounted on a flexible printed circuit film (not shown) and then mounted on the liquid crystal panel 300 in the form of a tape carrier package. Alternatively, the gate driving unit 400 or the data driving unit 500 may be integrated into the liquid crystal panel 300 together with, for example, the display signal lines G₁ to Gₙ and D₁ to Dₘ and the switching elements Q.

The signal control unit 600 receives input image signals R, G and B and input control signals for displaying the input image signals from an external graphic controller (not shown). Examples of the input control signal include a vertical synchronization signal Vsync, a horizontal synchronization signal Hsync, a main clock MCLK, a data enable signal DE, and the like.

The signal controller 600 generates the gate control signal CONT1 and the data control signal CONT2 on the basis of the input image signals R, G, and B and the input control signals. Then, the signal controller 600 transmits the gate control signal CONT1 to the gate driving unit 400 and transmits the data control signal CONT2 and an image signal DAT to the data driving unit 500.

The grayscale voltage generating unit 800 includes a plurality of resistors connected in series between a node to which the driving voltage AVDD is applied and ground, and divides the voltage level of the driving voltage AVDD to generate the plurality of grayscale voltages. The internal circuit of the grayscale voltage generating unit 800 is not limited thereto but can be variously realized.

According to the liquid crystal display 10 of the exemplary embodiment of the present invention, it is possible to prevent a residual image phenomenon from occurring after the power supply voltage Vcc is cut off.

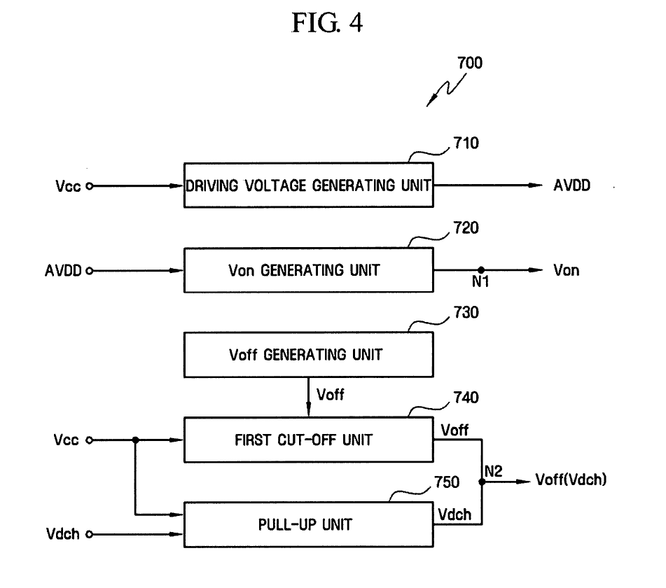

A voltage generating unit according to an exemplary embodiment of the present invention will be described with reference to FIG. 4. FIG. 4 is a block diagram for explaining the voltage generating unit of the liquid crystal display according to an exemplary embodiment of the present invention.

Referring to FIG. 4, the voltage generating unit 700 may include a driving voltage generating unit 710, a gate-on voltage generating unit 720, a gate-off voltage generating unit 730, and a pull-up unit 750.

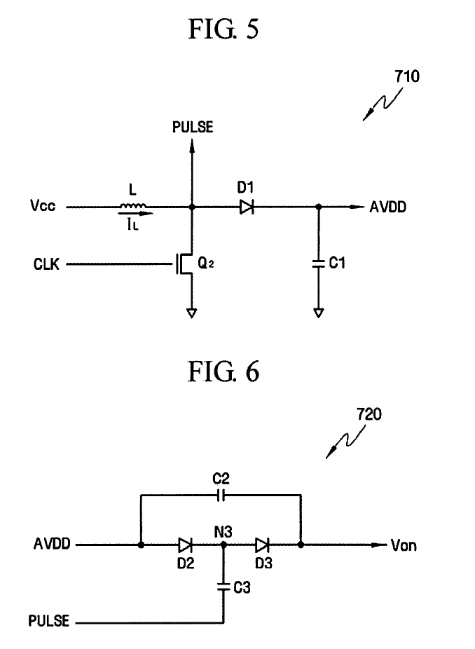

The driving voltage generating unit 710 is supplied with the power supply voltage Vcc from the outside and generates the driving voltage AVDD. As described above, the driving voltage AVDD is supplied to the grayscale voltage generating unit 800 so as to generate the plurality of grayscale voltages. The driving voltage AVDD is also supplied to the gate-on voltage generating unit 720. The internal circuit of the driving voltage generating unit 710 will be described later with reference to FIG. 5.

The gate-on voltage generating unit 720 is supplied with the driving voltage AVDD, generates the gate-on voltage Von, and outputs the gate-on voltage Von to the first output node N1. Alternatively, the gate-on voltage generating unit 720 may be supplied with another voltage instead of the driving voltage AVDD to generate the gate-on voltage Von. The internal circuit of the gate-on voltage generating unit 720 will be described later with reference to FIG. 6.

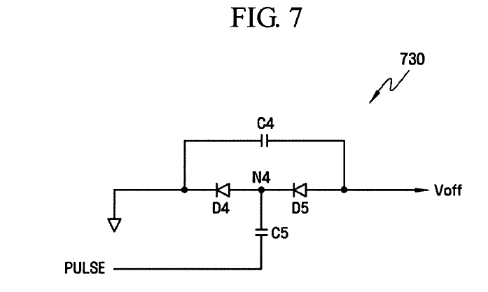

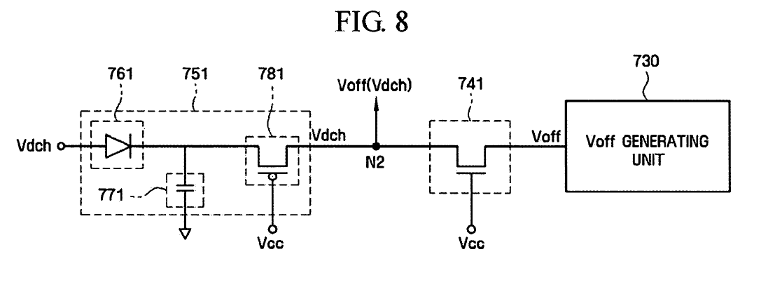

The gate-off voltage generating unit 730 generates the gate-off voltage Voff and outputs the gate-off voltage Voff through the second output node N2. In this case, the voltage generating unit 700 may further include a first cut-off unit 740 as shown in FIG. 4. The first cut-off unit 740 transmits the gate-off voltage Voff generated by the gate-off voltage generating unit 730 to the second output node N2. When the power supply voltage Vcc is cut off, however, the first cut-off unit 740 does not transmit the gate-off voltage Voff to the second output node N2. The gate-off voltage generating unit 730 will be described later with reference to FIG. 7, and the first cut-off unit 740 will be described later with reference to FIG. 8.

When the power supply voltage Vcc is cut off, the pull-up unit 750 outputs the discharge voltage Vdch to the second output node N2. For example, before the power supply voltage Vcc is cut off, die discharge voltage Vdch is charged in the pull-up unit 750, and when the power supply voltage Vcc is cut off, the pull-up unit 750 supplies the charged discharge voltage Vdch to the second output node N2, so as to pull the voltage level of the second output node N2 up to the level of the discharge voltage Vdch. In this exemplary embodiment, any of the gate-on voltage Von, the driving voltage AVDD, and the power supply voltage Vcc may be used as die discharge voltage Vdch. The internal circuit of the pull-up unit 750 will be described later with reference to FIG. 8.

More specifically, when the power supply voltage Vcc is supplied, that is, during the operation of the liquid crystal display, the discharge voltage Vdch is charged in the pull-up unit 750. When the power supply voltage Vcc is cut off, that is, when the liquid crystal display is turned off, the pull-up unit 750 supplies the discharge voltage Vdch to the second output node N2. Accordingly, instead of the gate-off voltage Voff, the positive discharge voltage Vdch is supplied to the gate line and, thus, the switching element (Q in FIG. 2) is turned on such that tie image data voltage having been charged in the pixel electrode (PE in FIG. 2) is discharged, thereby preventing the residual image phenomenon from occurring after the power supply voltage Vcc is cut off.

FIG. 5 is a circuit diagram illustrating an exemplary embodiment of the internal circuit of the driving voltage generating unit 710 shown in FIG. 4.

The driving voltage generating unit 710 shown in FIG. 5 is a boost converter and may include: an inductor L to which the power supply voltage Vcc is supplied; a first diode D1 having an anode connected to the inductor L and a cathode connected to an output terminal of the driving voltage source AVDD; a first capacitor C1 connected between the first diode D1 and ground; and a switching element Q2 that is connected between the anode of the first diode D1 and ground and that is turned on or off according to a clock signal CLK.

Now, the operation of the driving voltage generating unit 710 will be described. When the switching element Q2 is turned on, a current I_{L} flowing in the inductor L gradually increases. More specifically, the amount of current I_{L} flowing in the inductor L is adjusted according to a duty ratio of the clock signal CLK. When the switching element Q2 is turned off, the current I_{L} flowing in the inductor L is applied to the first capacitor C1 and, thus, a voltage is charged in the first capacitor C1 according to the current-voltage characteristic of the first capacitor C1. Therefore, the power supply voltage Vcc is boosted and is output as the driving voltage AVDD. Also, the driving voltage generating unit outputs a pulse signal PULSE.

The driving voltage generating unit 720 is supplied with the power supply voltage Vcc to be operated upon. When the power supply voltage is cut off, that is, when the liquid crystal display is turned off, the power supply voltage Vcc, the clock signal CLK, and the pulse signal PULSE serve as a ground voltage and, thus, decrease the driving voltage AVDD to the ground voltage.

The driving voltage generating unit 710 is not limited to this exemplary embodiment but may be a DC-DC converter, a buck converter, a forward converter, or a flyback converter, for example.

FIG. 6 is a circuit diagram illustrating an exemplary embodiment of the internal circuit of the gate-on voltage generating unit 720 shown in FIG. 4.

Referring to FIG. 6, the gate-on voltage generating unit 720 is a charge pumping circuit and includes second and third diodes D2 and D3 and second and third capacitors C2 and C3. The driving voltage AVDD is supplied to an anode of the second diode D2, and a cathode of the second diode D2 is connected to a first connection node N3. The third capacitor C3 supplies the pulse signal PULSE to the first connection node N3. An anode of the third diode D3 is connected to the first connection node N3 and the gate-on voltage Von is output from a cathode of the third diode D3. The second capacitor C2 is connected between the anode of the second diode D2 and the cathode of the third diode D3. The structure of the gate-on voltage generating unit 720, however, is not limited to this exemplary embodiment but may be formed of a combination of three or more diodes and three or more capacitors.

The operation of the gate-on voltage generating unit 720 will now be described. When the pulse signal PULSE is supplied to the third capacitor C3, a pulse having a level higher than the driving voltage AVDD by the voltage level of the pulse signal PULSE is output from the first connection node N3. The third capacitor C3 and the second capacitor C2 clamp the voltage of the first connection node N3, so as to output the gate-on voltage Von. That is, the gate-on voltage Von becomes substantially a DC voltage to which the driving voltage AVDD is shifted by the voltage level of the pulse signal PULSE.

The gate-on voltage generating unit 720 may include a capacitor (not shown) that is connected between the cathode of the third diode D3 and ground and that functions to charge the gate-on voltage Von and to prevent ripple of the gate-on voltage Von.

In the gate-on voltage generating unit 720, when the power supply voltage Vcc is cut off, since the driving voltage AVDD and the pulse signal PULSE decrease to ground voltage, the gate-on voltage Von gradually decreases to ground voltage.

FIG. 7 is a circuit diagram illustrating an example of the internal circuit of the gate-off voltage generating unit 730 shown in FIG. 4.

Referring to FIG. 7, the gate-off voltage generating unit 730 includes fourth and fifth diodes D4 and D5 and fourth and fifth capacitors C4 and C5. A cathode of the fourth diode D4 is connected to ground and an anode of the fourth diode D4 is connected to a second connection node N4. The fifth capacitor C5 applies die pulse signal PULSE to the second connection node N4. A cathode of the fifth diode D5 is connected to the second connection node N4 and the gate-off voltage Voff is output from an anode of the fifth diode D5. The fourth capacitor C4 is connected between the cathode of the fourth diode D4 and the anode of the fifth diode D5. The structure of the gate-off voltage generating unit 730 is not limited to this exemplary embodiment, however, but may be formed of a combination of three or more diodes and three or more capacitors.

The operation of the gate-off voltage generating unit 730 will now be described. When the pulse signal PULSE is supplied to the fifth capacitor C5, a pulse having a level lower than ground voltage by the voltage level of the pulse signal PULSE is output from the second connection node N4. The fourth diode D4 and the fourth capacitor C4 clamp the voltage of the second connection node N4 so as to output the gate-off voltage Voff. More specifically, the gate-off voltage Voff becomes substantially a DC voltage to which the ground voltage is shifted to the voltage level of the pulse signal PULSE.

In the gate-off voltage generating unit 730, when the power supply voltage Vcc is cut off, since the pulse signal PULSE decreases to ground voltage, the gate-off voltage Voff gradually increases to ground voltage.

An exemplary embodiment of the internal circuit of the pull-up unit 750 and the first cut-off unit 740 shown in FIG. 4 will be described with reference to FIG. 8. FIG. 8 is a circuit diagram for explaining the pull-up unit and the first cut-off unit of the liquid crystal display according to an exemplary embodiment of the present invention. In FIG. 8, an exemplary embodiment of the first cut-off unit is shown at 741 and an exemplary embodiment of the pull-up unit is shown at 751.

Referring to FIG. 8, during the operation of the liquid crystal display, the gate-off voltage Voff is output from the second output node N2. When the power supply voltage Vcc is cut off, the discharge voltage Vdch is output from the second output node N2.

More specifically, first, during the operation of the liquid crystal display, when the power supply voltage Vcc is at a high level, the first cut-off unit 741 transmits the gate-off voltage Voff to the second output node N2. In this exemplary embodiment, the first cut-off unit 741 may be an NMOS transistor.

At this time, the pull-up unit 751 is charged with the discharge voltage Vdch.

The pull-up unit 751 includes a charge unit 771 charged with the discharge voltage Vdch and a switching unit 781. When the power supply voltage Vcc is cut off, the switching unit 781 is enabled to output the charged discharge voltage to the second output node N2. As shown in FIG. 8, the pull-up unit 751 may further include a second cut-off unit 761 that supplies the discharge voltage Vdch to the charge unit 771 and electrically cuts off the discharge voltage Vdch from the charge unit 771 when the power supply voltage is cut off.

More specifically, the charge unit 771 includes, for example, a capacitor, and is charged with the discharge voltage Vdch during the operation of the liquid crystal display. In this case, the switching unit 781 is disabled by the presence of the power supply voltage Vcc, so as not to output the voltage charged in tie charge unit 771 to the second output node N2. The switching unit 781 may include a PMOS transistor. The second cut-off unit 761 includes, for example, a diode, and allows an electric current to flow when the voltage level of the discharge voltage Vdch is higher than the voltage charged in the charge unit 771, so as to supply the discharge voltage Vdch to the charge unit 771. In this exemplary embodiment, the discharge voltage Vdch may be any one of the gate-on voltage Von, the driving voltage AVDD, and the power supply voltage Vcc.

Next, when the liquid crystal display is turned off, that is, when the power supply voltage Vcc is cut off (changed to a low level), the first cut-off unit 741 electrically disconnects the gate-off voltage generating unit 730 and the second output node N2. Therefore, the gate-off voltage Voff is not output from the second output node N2.

When the power supply voltage Vcc is cut off, that is, when the voltage supplied to the liquid crystal display is cut off, the discharge voltage Vdch starts to decrease. For example, the discharge voltage Vdch may be any one of the gate-on voltage Von, the driving voltage AVDD, and the power supply voltage Vcc. As described above, the gate-on voltage Von and the driving voltage AVDD are generated when the power supply voltage Vcc is supplied and decrease to the ground voltage when the power supply voltage Vcc is cut off. Therefore, when the power supply voltage Vcc is cut off, the second cut-off unit 761 electrically disconnects the discharge voltage Vdch and the charge unit 771, so as not to discharge the voltage charged in the charge unit 771 to the decreased discharge voltage Vdch.

When the power supply voltage Vcc is cut off, the switching unit 781 is enabled to supply the discharge voltage Vdch charged in the charge unit 771 to the second output node N2.

Therefore, when the power supply voltage Vcc is cut off, the second output node N2 is charged with the positive discharge voltage Vdch.

A case in which the first cut-off unit 741 and the switching unit 781 each are enabled or disabled by the power supply voltage has been described above. The invention is not limited, however, to that exemplary embodiment. The first cut-off unit 741 and the switching unit 781 each may be enabled or disabled according to the gate-on voltage Von or the driving voltage AVDD. As described above, since the gate-on voltage Von and the driving voltage are generated when the power supply voltage Vcc is supplied and are decreased to the ground voltage when the power supply voltage Vcc is cut off, the gate-on voltage Von and the driving voltage AVDD can each function as the power supply voltage Vcc. That is why the first cut-off unit 741 and the switching unit 781 each may be enabled or disabled according to the gate-on voltage Von or the driving voltage AVDD.

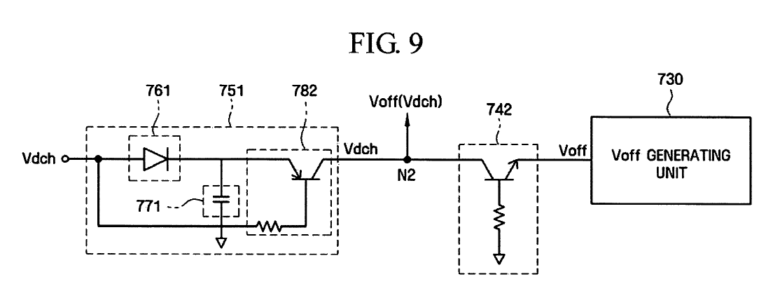

A liquid crystal display according to an exemplary embodiment of the present invention will now be described with reference to FIG. 9. FIG. 9 is a circuit diagram for explaining a pull-up unit and a first cut-off unit of a liquid crystal display according to an exemplary embodiment of the present invention. Components shown in FIG. 9, having the same functions as those shown in FIG. 8, are denoted by the same reference symbols and a detailed description thereof will be omitted for ease of explanation. In FIG. 9, an exemplary embodiment of the cut-off unit is shown at 742, and an exemplary embodiment of the pull-up unit is shown at 751.

Referring to FIG. 9, a switching unit 782 includes a PNP-type bipolar junction transistor (BJT) and a first cut-off unit 742 includes a NPN-type BJT.

The operation of the switching unit 782 and the first cut-off unit 742 will now be described. When the power supply voltage Vcc is cut off, the voltage level of the discharge voltage Vdch starts to decrease. Therefore, the PNP-type BJT of the switching unit 782 is turned on so as to transmit the discharge voltage Vdch charged in the charge unit 771 to the second output node N2.

As described above, when the power supply voltage Vcc is cut off, the voltage level of the gate-off voltage Voff starts to increase to ground voltage. Therefore, the NPN-type BJT of the first cut-off unit 742 is turned off so as to electrically disconnect the gate-off voltage generating unit 730 and the second output node N2.

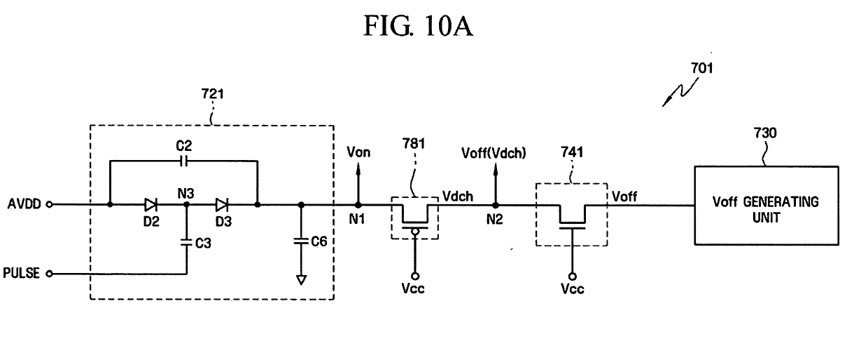

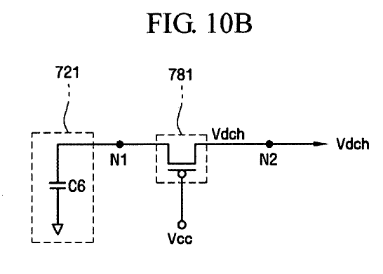

Hereinafter, a liquid crystal display according to an exemplary embodiment of the present invention will be described with reference to FIGS. 10A and 10B. FIGS. 10A and 10B are circuit diagrams illustrating a voltage generating unit of a liquid crystal display according to an exemplary embodiment of the present invention. Components shown in FIGS. 10A and 10B, having the same functions as those shown in FIGS. 4 and 8, are denoted by the same reference symbols and a detailed description thereof will be omitted for ease of explanation.

First, referring to FIG. 10A, a voltage generating unit 701 includes a gate-on voltage generating unit 721, a gate-off voltage generating unit 730, a switching unit 781, and a first cut-off unit 741.

During the operation of the liquid crystal display, that is, before the power supply voltage Vcc is cut off, the gate-on voltage generating unit 721 and the gate-off voltage generating unit 730 generate the gate-on voltage Von and the gate-off voltage Voff, respectively.

The gate-on voltage generating unit 721 may include a charge unit C6 that is charged with the gate-on voltage Von and that prevents tipple of the gate-on voltage Von as described above. The charge unit C6 may be a capacitor connected between the first output node N1 and ground. The charge unit C6 is charged with the gate-on voltage Von.

At this time, since the switching unit 781 is disabled by the power supply voltage Vcc, the switching unit 781 electrically disconnects tie first output node N1 and the second output node N2. The first cut-off unit 741 is enabled by the power supply voltage so as to transmit the gate-off voltage Voff to the second output node N2. Therefore, the gate-on voltage Von is output from the first output node N1 and the gate-off voltage Voff is output from the second output node N2.

Next, when the power supply voltage Vcc is cut off (is changed to the low level), the voltage levels of the pulse signal PULSE and the driving voltage AVDD decrease to ground voltage. Therefore, the voltage of the anode of the second diode D2 is changed to the ground voltage, and the voltage level of the first connection node N3 decreases by a predetermined level. Since the voltage level of the first output node N1 is the level of the gate-on voltage Von, both of the second diode D2 and the third diode D3 are turned off. Further, the second cut-off unit 741 electrically disconnects the gate-off voltage generating unit 730 and the second output node N2. Therefore, when the power supply voltage Vcc is cut off, the voltage generating unit 701 shown in FIG. 10A becomes the same as the circuit shown in FIG. 10B.

Referring to FIG. 10B, in a state in which tie charge unit C6 has been charged with the gate-on voltage Von, when the power supply voltage Vcc is cut off, the switching unit 781 supplies the gate-on voltage Von charged in the charge unit C6 to die second output node N2.

In this exemplary embodiment, a case where each the first cut-off unit 741 and the switching unit 781 are enabled or disabled by the power supply voltage has been described. The invention is not limited to this exemplary embodiment, however. Each of the first cut-off unit 741 and the switching unit 781 may be enabled or disabled according to the gate-on voltage Von or the driving voltage AVDD.

According to the liquid crystal display including the voltage generating unit 701, even after the power supply voltage Vcc is cut off, the gate-on voltage Von is supplied to the first switching element (Q in FIG. 1) of each pixel (PX in FIG. 1) so as to turn on tie first switching element (PX in FIG. 1) such that the image data voltage is discharged. As a result, it is possible to prevent the residual image phenomenon from occurring after the power supply voltage Vcc is cut off.

Although the present invention has been described in connection with the exemplary embodiments, it will be apparent to those of ordinary skill in the art that various modifications and changes may be made thereto without departing from the scope and spirit of the invention. Therefore, it should be understood that the exemplary embodiments are not limitative, but illustrative in all aspects.

According to the liquid crystal display according to any of the exemplary embodiments of the present invention, even after the power supply voltage is cut off, the positive discharge voltage or the gate-on voltage is supplied to the first switching element of each pixel so as to turn on the first switching element such that the image data voltage is discharged. As a result, it is possible to prevent the residual image phenomenon from occurring after the power supply voltage is cut off.

What is claimed is:

1. A liquid crystal display comprising:
a voltage generating unit outputting a gate-on voltage to a first output node, outputting a gate-off voltage to a second output node, and pulling up a voltage level of the second output node to a level of a positive discharge voltage after a power supply voltage is cut off;
a gate driving unit sequentially supplying the gate-on voltage and the gate-off voltage;
a data driving unit supplying an image data voltage; and
a liquid crystal panel comprising a plurality of pixels that are turned on or off according to the gate-on voltage or the gate-off voltage so as to display an image corresponding to the image data voltage.

2. The liquid crystal display of claim 1, wherein after the power supply voltage is cut off, each of the plurality of pixels discharges the image data voltage.

3. The liquid crystal display of claim 2, wherein
each of the plurality of pixels comprises a switching element that is turned on or off according to the gate-on voltage or the gate-off voltage, and
after the power supply voltage is cut off, the switching element is supplied with the discharge voltage so as to be turned on.

4. The liquid crystal display of claim 1, wherein
the voltage generating unit comprises:
a gate-off voltage generating unit generating the gate-off voltage; and
a pull-up unit pulling the voltage level of the second node up to the level of the positive discharge voltage after the power supply voltage is cut off.

5. The liquid crystal display of claim 4, wherein
the pull-up unit comprises:
a charge unit being charged with the positive discharge voltage; and
a switching unit enabled so as to pull up the voltage level of the second output node to the level of the discharge voltage, when the power supply voltage is cut off.

6. The liquid crystal display of claim 5, wherein the switching unit comprises a PMOS transistor.

7. The liquid crystal display of claim 5, wherein the switching unit comprises a PNP-type bipolar junction transistor.

8. The liquid crystal display of claim 5, wherein the pull-up unit further comprises a cut-off unit that supplies the discharge voltage to the charge unit and electrically cuts off the discharge voltage from the charge unit when the power supply voltage is cut off.

9. The liquid crystal display of claim 8, wherein the cut-off unit comprises a diode having an anode to which the discharge voltage is applied and a cathode connected to the charge unit.

10. The liquid crystal display of claim 4, wherein the voltage generating unit further comprises a cut-off unit that electrically disconnects the second output node and the gate-off voltage generating unit when the power supply voltage is cut off.

11. The liquid crystal display of claim 10, wherein the cut-off unit comprises an NMOS transistor.

12. The liquid crystal display of claim 10, wherein: the cut-off unit comprises an NPN-type bipolar junction transistor.

13. A liquid crystal display comprising:
a voltage generating unit including a gate-on voltage generating unit outputting a gate-on voltage to a first output node, a gate-off voltage generating unit outputting a gate-off voltage to a second output node, a pull-up unit pulling up the voltage level of the second output node to a level of the gate-on voltage when a power supply voltage is cut off, and a first cut-off unit electrically disconnecting the second output node and the gate-off voltage generating unit when the power supply voltage is cut off;
a gate driving unit sequentially supplying the gate-on voltage and the gate-off voltage;
a data driving unit supplying an image data voltage; and
a liquid crystal panel including a plurality of pixels that are turned on or off according to the gate-on voltage or the gate-off voltage so as to display an image corresponding to the image data voltage, each pixel being supplied with the gate-on voltage so as to discharge the image data voltage when the power supply voltage is cut off.

14. The liquid crystal display of claim 13, wherein
the pull-up unit comprises:
a charge unit being charged with the gate-on voltage;
a switching unit enabled when the power supply is cut off so as to pull up the voltage level of the second output node to the level of the gate-on voltage; and
a second cut-off unit connected to the first output node to supply the gate-on voltage to the charge unit and electrically disconnect the first output node from the charge unit when the power supply voltage is cut off.

15. The liquid crystal display of claim 14, wherein the second cut-off unit comprises a diode having an anode connected to the first output node and a cathode connected to the charge unit.

16. The liquid crystal display of claim 14, wherein: the switching unit comprises a PMOS transistor or a PNP-type bipolar junction transistor.

17. The liquid crystal display of claim 13, wherein
the gate-on voltage generating unit comprises
a charge pumping unit outputting to the first output node the gate-on voltage to which the power supply voltage is shifted by a voltage level of a pulse signal, and
a charge unit connected between the first output node and ground and charged with the gate-on voltage so as to prevent ripple of the gate-on voltage, and
the pull-up unit including a switching unit that is enabled to supply the gate-on voltage charged in the charge unit to the second output node when the power supply voltage is cut off.

18. The liquid crystal display of claim 17, wherein the switching unit comprises a PMOS transistor or a PNP-type bipolar junction transistor.

19. The liquid crystal display of claim 17, wherein the first cut-off unit comprises an NMOS transistor or an NPN-type bipolar junction transistor.
